(19) United States
(12) Patent Application Publication
(10) Pub. No.: US 2014/0133294 A1
(43) Pub. Date: May 15, 2014

(54) Methods and Systems for Broadcasting Load Information to Enable a User Equipment (UE) to Select Different Network Access

(71) Applicant: QUALCOMM Incorporated, San Diego, CA (US)

(72) Inventors: Gavin Bernard HORN, La Jolla, CA (US); Masato KITAZOE, Tokyo (JP); Francesco PICA, San Diego, CA (US)

(73) Assignee: QUALCOMM INCORPORATED, San Diego, CA (US)

(21) Appl. No.: 14/073,257

(22) Filed: Nov. 6, 2013

Related U.S. Application Data
(60) Provisional application No. 61/724,798, filed on Nov. 9, 2012.

(51) Int. Cl. H04W 28/02

(52) U.S. Cl. CPC H04W 28/0247
USPC 370/230; 455/436

(57) ABSTRACT

Methods and apparatus for offloading traffic from a first RAT network (e.g., WWAN) to a second RAT network (e.g., WLAN) are described. In some cases, the first RAT network may broadcast an indication of a level of preference for offloading traffic for one or more application types to the first or second RAT network. A UE may determine which RAT network to use for transmitting data based on this indication and current system conditions (e.g., relative loading of the first and second RAT networks).

### CROSS-REFERENCE TO RELATED APPLICATIONS

The present patent application claims priority to U.S. Provisional Application No. 61/724,798, filed Nov. 09, 2012, assigned to the assignee of the present application and hereby expressly incorporated by reference in its entirety.

### FIELD OF THE DISCLOSURE

Certain aspects of the present disclosure generally relate to wireless communications and, more particularly, to methods and systems for broadcasting load information to enable a user equipment (UE) to select different network for routing traffic based at least in part on an application.

### BACKGROUND OF THE DISCLOSURE

Wireless communication networks are widely deployed to provide various communication services such as voice, video, packet data, messaging, and broadcast services. These wireless communication networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

As wireless communication technology advances, a growing number of different radio access technologies are being utilized. For instance, many geographic areas are now served by multiple wireless communication systems, each of which can utilize one or more different radio access technologies (RATs). In order to increase versatility of UEs in such systems, there recently has been an increasing trend toward multi-mode UEs that are able to operate in networks using multiple different types of RATs. For example, a multi-mode UE may be able to operate in both wireless wide area networks (WWANs) and wireless local area networks (WLANs).

In some cases, networks that support such multi-mode operation by a UE may allow traffic to be offloaded from a first RAT, such as for a WWAN to a second RAT, such as for a WLAN.

### SUMMARY OF THE DISCLSOURE

Certain aspects of the present disclosure provide a method for managing load of a communication system. The method may include managing load at a wireless node. The method generally includes determining, based on a level of congestion in a first radio access technology (RAT) network, an indication of a level of preference for one or more application types to route data traffic of the one or more application types to the first RAT network or a second RAT network and transmitting the indication to a user equipment (UE).

Certain aspects of the present disclosure provide a method for determining whether to send traffic on a first radio access technology (RAT) network or a second RAT network for an application. The method generally includes obtaining data traffic of the one or more application types to send, receiving an indication of a level of preference to access the first RAT network or the second RAT network , wherein the indication is based at least in part on the one or more application types, and determining, based on the one or more application types, a quality of the at least one of the first RAT network and the second RAT network and the indication of the level of preference, whether to send the data traffic of the one or more application types via the first RAT network or the second RAT network.

Certain aspects of the present disclosure provide an apparatus for managing load at a wireless node. The apparatus generally includes at least one processor configured to determine, based on a level of congestion in a first radio access technology (RAT) network, an indication of a level of preference for one or more application types to route data traffic of the one or more application types to the first RAT network or a second RAT network; and a transmitter configured to transmit the indication to a user equipment (UE).

Certain aspects of the present disclosure provide an apparatus for determining whether to send traffic on a first radio access technology (RAT) network or a second RAT network for one or more application types. The apparatus generally includes a receiver configured to receive an indication of a level of preference to access the first RAT network or the second RAT network, wherein the indication is based at least in part on one or more application types; and at least one processor configured to obtain data traffic of the one or more application types to send and determine, based on the one or more application types, a quality of the at least one of the first RAT network and the second RAT network and the indication of the level of preference, whether to send the data traffic of the one or more application types via the first RAT network or the second RAT network.

Various aspects and features of the disclosure are described in further detail below.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communication system, in accordance with an aspect of the present disclosure.

FIG. 2 is a block diagram conceptually illustrating an example of a bearer architecture in a wireless communications system 200, in accordance with an aspect of the present disclosure.

FIG. 3 is a block diagram conceptually illustrating an exemplary eNodeB and an exemplary UE configured in accordance with an aspect of the present disclosure.

FIG. 4 illustrates a block diagram conceptually illustrating an aggregation of wireless local area network (WLAN) and a wireless wide area network (WWAN) radio access technologies (RATs) at a user equipment (UE), in accordance with an aspect of the present disclosure.

FIGS. 5A and 5B illustrate an exemplary reference architecture for a wireless local area network (WLAN) and a wireless wide area network (WWAN) access interworking, in accordance with certain aspects of the present disclosure.

FIG. 6 illustrates exemplary policies for managing traffic, in accordance with certain aspects of the present disclosure.

FIGS. 7A and 7B illustrate an exemplary application of one of the policies shown in FIG. 6 to route traffic during different network conditions.

FIG. 8 illustrates an exemplary method for managing traffic, in accordance with certain aspects of the present disclosure.

FIG. 9 illustrates an exemplary method for managing traffic, in accordance with certain aspects of the present disclosure.

### DETAILED DESCRIPTION

Aspects of the present disclosure provide techniques that may be used to offload traffic from a first radio access technology (RAT) network to a second RAT network. A network utilizing a particular RAT is referred to herein as a RAT network or simply a Radio Access Network (RAN). Thus, RAN refers to a network, while RAT refers to a type of technology that a network uses.

In accordance with aspects of the present disclosure, the first RAT network may be a wide area wireless network (WWAN), for example, a cellular network (e.g., a 3G and/or 4G network), while the second RAT network may be a wireless local area network (WLAN), for example, a Wi-Fi network. As provided herein, in making offloading decisions, a UE may consider various conditions in both networks (e.g., relative loading) and/or current service requirements of its applications in order to determine a RAT network that may be suitable for offloading. In this manner, offloading decisions may be made on a per-application basis, with different considerations for different application types.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2).

Single carrier frequency division multiple access (SC-FDMA) is a transmission technique that utilizes single carrier modulation at a transmitter side and frequency domain equalization at a receiver side. The SC-FDMA has similar performance and essentially the same overall complexity as those of OFDMA system. However, SC-FDMA signal has lower peak-to-average power ratio (PAPR) because of its inherent single carrier structure. The SC-FDMA has drawn great attention, especially in the uplink communications where lower PAPR greatly benefits the mobile terminal in terms of transmit power efficiency. It is currently a working assumption for uplink multiple access scheme in the 3GPP LTE and the Evolved UTRA.

A base station (“BS”) may comprise, be implemented as, or known as NodeB, Radio Network Controller (“RNC”), Evolved NodeB (eNodeB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A user equipment (UE) may comprise, be implemented as, or known as an access terminal, a subscriber station, a subscriber unit, a remote station, a remote terminal, a mobile station, a user agent, a user device, user equipment, a user station, or some other terminology. In some implementations, mobile station may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

### An Example Wireless Communication System

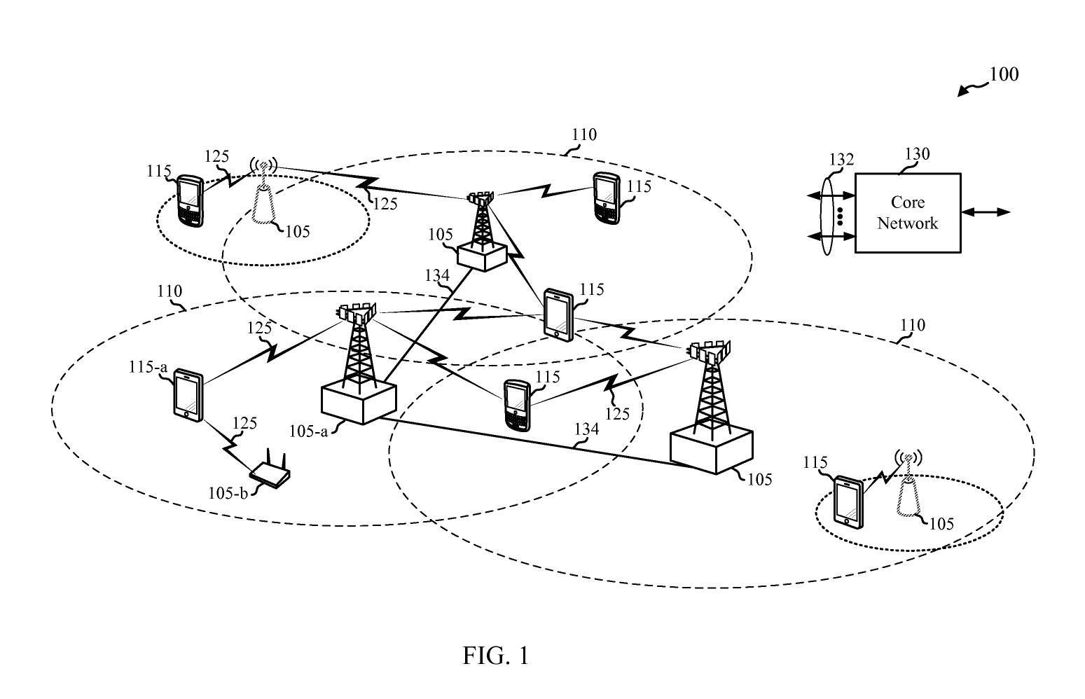

Referring to FIG. 1, a multiple access wireless communication system in accordance with certain aspects of the present disclosure is illustrated. The multiple access wireless communication system 100 may support techniques for offloading traffic from one radio access technology (RAT) network to another. For example, FIG. 1 illustrates an exemplary multi-mode user equipment (UE) 115-a that may be capable of determining on a per-application basis, to which radio access technology (RAT) network it should route traffic, in accordance with aspects of the present disclosure.

The wireless communications system 100 includes base stations (or cells) 105, user equipment (UEs) 115, and a core network 130. The base stations 105 may communicate with the UEs 115 under the control of a base station controller (not shown), which may be part of the core network 130 or the base stations 105 in various embodiments. The base stations 105 may communicate control information and/or user data with the core network 130 through first backhaul links 132. In embodiments, the base stations 105 may communicate, either directly or indirectly, with each other over second backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the UEs 115 via one or more base station antennas. Each of the base stations 105 sites may provide communication coverage for a respective geographic coverage area 110. In some embodiments, base stations 105 may be referred to as a base transceiver station, a radio base station, an access point, a radio transceiver, a basic service set (BSS), an extended service set (ESS), a NodeB, eNodeB, Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro, micro, and/or pico base stations). There may be overlapping coverage areas for different technologies.

In embodiments, the wireless communications system 100 is an LTE/LTE-A network communication system. In LTE/LTE-A network communication systems, the terms evolved Node B (eNodeB) may be generally used to describe the base stations 105. The wireless communications system 100 may be a Heterogeneous LTE/LTE-A network in which different types of eNodeBs provide coverage for various geographical regions. For example, each eNodeB 105 may provide communication coverage for a macro cell, a pico cell, a femto cell, and/or other types of cell. A macro cell generally covers a relatively large geographic area (e.g., several kilometers in radius) and may allow unrestricted access by UEs 115 with service subscriptions with the network provider. A pico cell would generally cover a relatively smaller geographic area (e.g., buildings) and may allow unrestricted access by UEs 115 with service subscriptions with the network provider. A femto cell would also generally cover a relatively small geographic area (e.g., a home) and, in addition to unrestricted access, may also provide restricted access by UEs 115 having an association with the femto cell (e.g., UEs 115 in a closed subscriber group (CSG), UEs 115 for users in the home, and the like). An eNodeB 105 for a macro cell may be referred to as a macro eNodeB. An eNodeB 105 for a pico cell may be referred to as a pico eNodeB. And, an eNodeB 105 for a femto cell may be referred to as a femto eNodeB or a home eNodeB. An eNodeB 105 may support one or multiple (e.g., two, three, four, and the like) cells.

The core network 130 may communicate with the eNodeBs 105 or other base stations 105 via first backhaul links 132 (e.g., S1 interface, etc.). The eNodeBs 105 may also communicate with one another, e.g., directly or indirectly via second backhaul links 134 (e.g., X2 interface, etc.) and/or via the first backhaul links 132 (e.g., through core network 130). The wireless communications system 100 may support synchronous or asynchronous operation. For synchronous operation, the eNodeBs 105 may have similar frame timing, and transmissions from different eNodeBs 105 may be approximately aligned in time. For asynchronous operation, the eNodeBs 105 may have different frame timing, and transmissions from different eNodeBs 105 may not be aligned in time. The techniques described herein may be used for either synchronous or asynchronous operations.

The communication links 125 shown in the wireless communications system 100 may include uplink (UL) transmissions from a UE 115 to an eNodeB 105, and/or downlink (DL) transmissions, from an eNodeB 105 to a UE 115. The downlink transmissions may also be called forward link transmissions while the uplink transmissions may also be called reverse link transmissions.

In certain examples, a UE 115 may be capable of simultaneously communicating with multiple eNodeBs 105. When multiple eNodeBs 105 support a UE 115, one of the eNodeBs 105 may be designated as the anchor eNodeB 105 for that UE 115, and one or more other eNodeBs 105 may be designated as the assisting eNodeBs 105 for that UE 115. For example, an assisting eNodeB 105 is associated with a local gateway communicatively coupled to a packet data network (PDN), core network resources may be conserved by offloading a portion of network traffic between the UE 115 and that PDN through the local gateway of the assisting eNodeB 105 rather than transmitting the traffic through the core network 130.

As described above, a multi-mode UE 115-a may be capable of communicating via multiple RATs. For example, UE 115-a may be able to communicate with a first RAT network (e.g., WWAN) via an eNodeB 105-a and a second RAT network (e.g., WLAN) via an access point 105-b. Multi-mode UE 115-a may be configured to determine which of the WWAN or WLAN is suitable for routing traffic, in accordance with aspects of the present disclosure. For example, in an offload process a network provider may direct the multi-mode UE 115-a to offload data traffic for certain applications to the WLAN from the WWAN when the WLAN is available, when certain conditions are met. According to certain aspects of the present disclosure, the multi-mode UE 115-a may help in this offloading process by deciding which RAT network to use for certain applications, for example, based on network information. This capability may allow a network provider to help control how traffic is routed in a manner that eases congestion of network resources of a first RAT network (e.g., WWAN. In this manner, the network provider may use local area RAT networks to carry some data traffic (of a wide area RAT network). The traffic may be re-routed from the local RAT network when appropriate, such as when a mobile user increases speed to a certain level and the UE is likely to move out the local RAT network coverage area.

Further, since wide area RAT networks are typically designed to provide service over several kilometers, the power consumption of transmissions from a multi-mode UE 115-a when using a wide area RAT network is non-trivial. In contrast, local area RAT networks (e.g., WLANs) are typically designed to provide service coverage over-at most- several hundred meters. Accordingly, utilizing a local area RAT network when available may result in less power consumption by the multi-mode UE 115-a and, consequently, longer battery life.

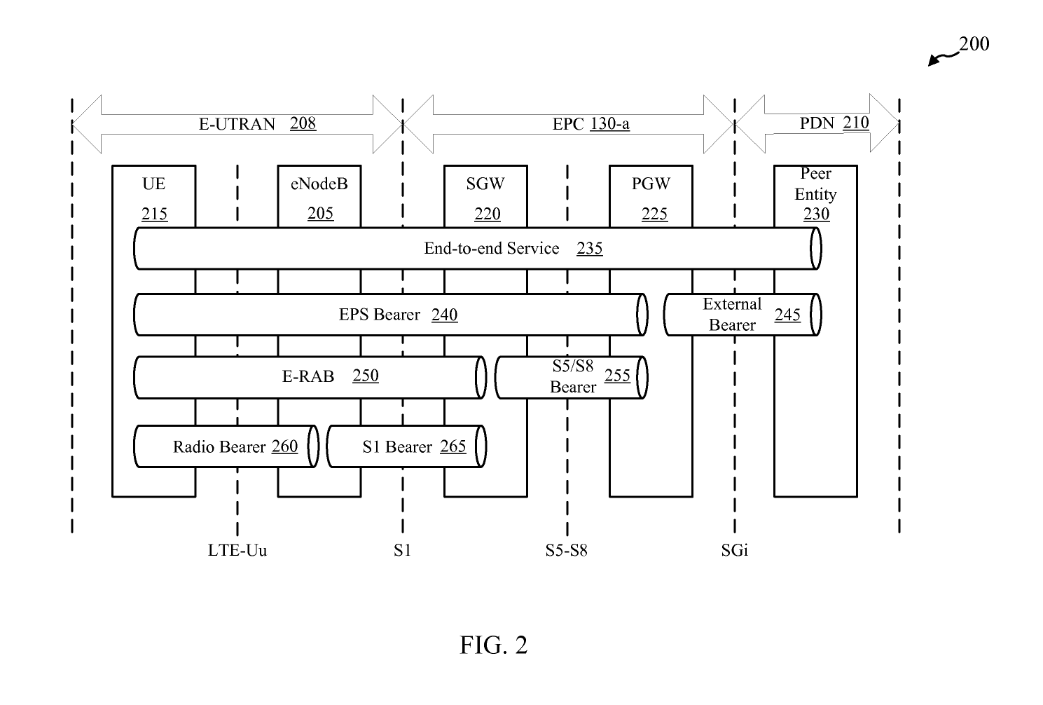

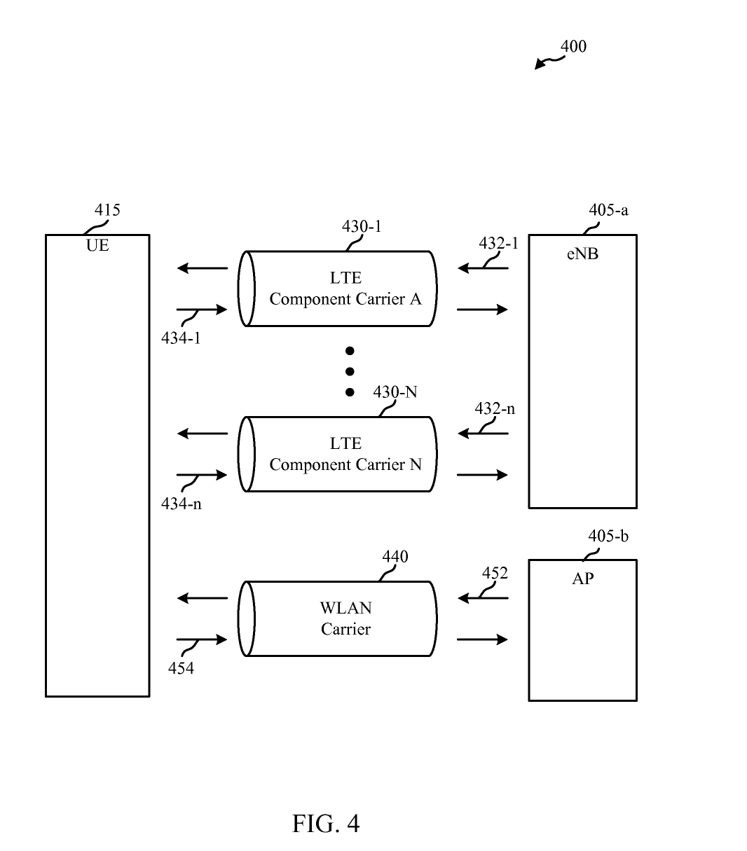

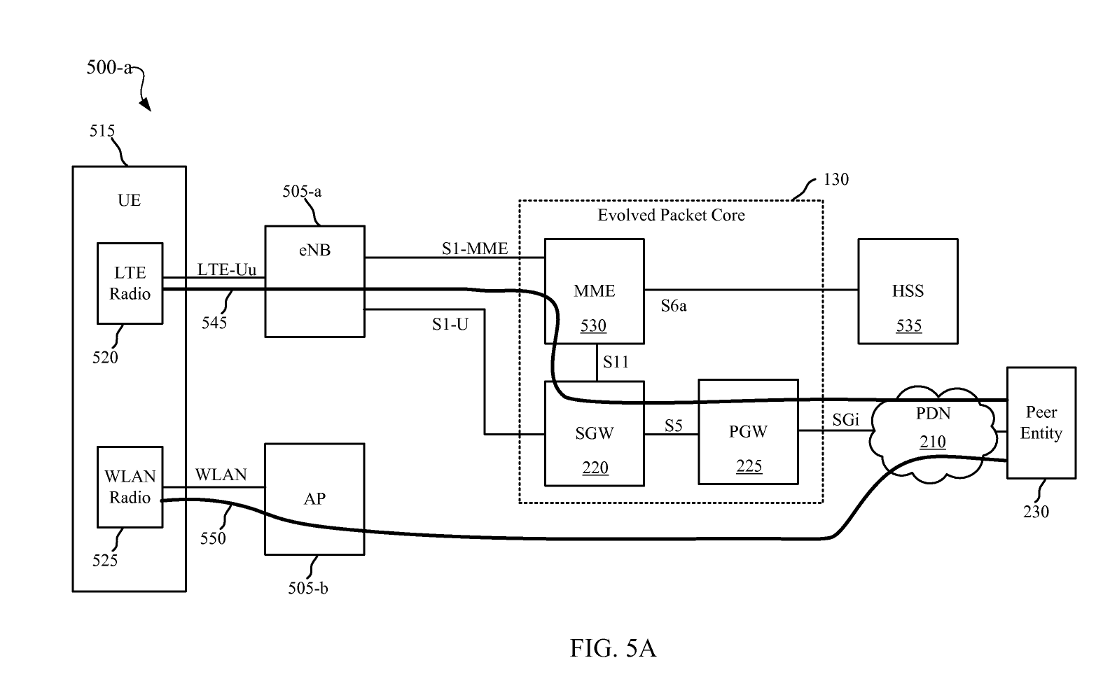

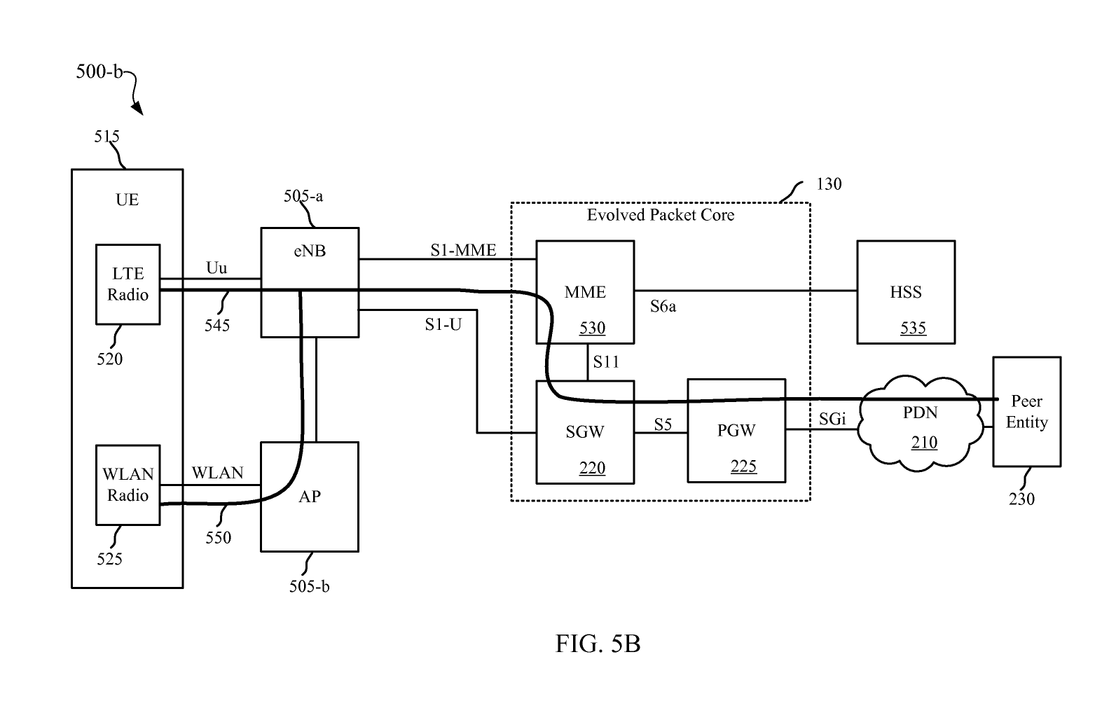

FIG. 2 is a block diagram conceptually illustrating an example of a bearer architecture in a wireless communications system 200, in accordance with an aspect of the present disclosure. The bearer architecture may be used to provide an end-to-end service 235 between a UE 215 and a peer entity 230 addressable over a network. The bearer architecture illustrated in FIG. 2 may be implemented in a wide area RAT network (e.g., WWAN). As noted above, a multi-mode UE may also be able to communicate via a local area RAT network (e.g., WLAN), as will be described in greater detail below with reference to FIGS. 4, 5A, and 5B.

The peer entity 230 may be a server, another UE, or another type of network-addressable device. The end-to-end service 235 may forward data between UE 215 and the peer entity 230 according to a set of characteristics (e.g., QoS) associated with the end-to-end service 235. The end-to-end service 235 may be implemented by at least the UE 215, an eNodeB 205, a serving gateway (SGW) 220, a packet data network (PDN) gateway (PGW) 225, and the peer entity 230. The UE 215 and eNodeB 205 may be components of an evolved UMTS terrestrial radio access network (E-UTRAN) 208, which is the air interface of the LTE/LTE-A systems. The serving gateway 220 and PDN gateway 225 may be components of an evolved Packet Core (EPC) 209, which is the core network architecture of LTE/LTE-A systems. The peer entity 230 may be an addressable node on a PDN 210 communicatively coupled with the PDN gateway 225.

The end-to-end service 235 may be implemented by an evolved packet system (EPS) bearer 240 between the UE 215 and the PDN gateway 225, and by an external bearer 245 between the PDN gateway 225 and the peer entity 230 over an SGi interface. The SGi interface may expose an internet protocol (IP) or other network-layer address of the UE 215 to the PDN 210.

The EPS bearer 240 may be an end-to-end tunnel defined to a specific QoS. Each EPS bearer 240 may be associated with a plurality of parameters, for example, a QoS class identifier (QCI), an allocation and retention priority (ARP), a guaranteed bit rate (GBR), and an aggregate maximum bit rate (AMBR). The QCI may be an integer indicative of a QoS class associated with a predefined packet forwarding treatment in terms of latency, packet loss, GBR, and priority. In certain examples, the QCI may be an integer from 1 to 9. The ARP may be used by a scheduler of an eNodeB 205 to provide preemption priority in the case of contention between two different bearers for the same resources. The GBR may specify separate downlink and uplink guaranteed bit rates. Certain QoS classes may be non-GBR such that no guaranteed bit rate is defined for bearers of those classes.

The EPS bearer 240 may be implemented by an E-UTRAN radio access bearer (E-RAB) 250 between the UE 215 and the serving gateway 220, and an S5/S8 bearer 255 between the serving gateway 220 and the PDN gateway over an S5 or S8 interface. S5 refers to the signaling interface between the serving gateway 220 and the PDN gateway 225 in a non-roaming scenario, and S8 refers to an analogous signaling interface between the serving gateway 220 and the PDN gateway 225 in a roaming scenario. The E-RAB 250 may be implemented by a radio bearer 260 between the UE 215 and the eNodeB 205 over an LTE-Uu air interface and by an S1 bearer 265 between the eNodeB and the serving gateway 220 over an S1 interface.

It will be understood that, while FIG. 2 illustrates the bearer hierarchy in the context of an example of end-to-end service 235 between the UE 215 and the peer entity 230, certain bearers may be used to convey data unrelated to end-to-end service 235. For example, radio bearers 260 or other types of bearers may be established to transmit control data between two or more entities where the control data is unrelated to the data of the end-to-end service 235.

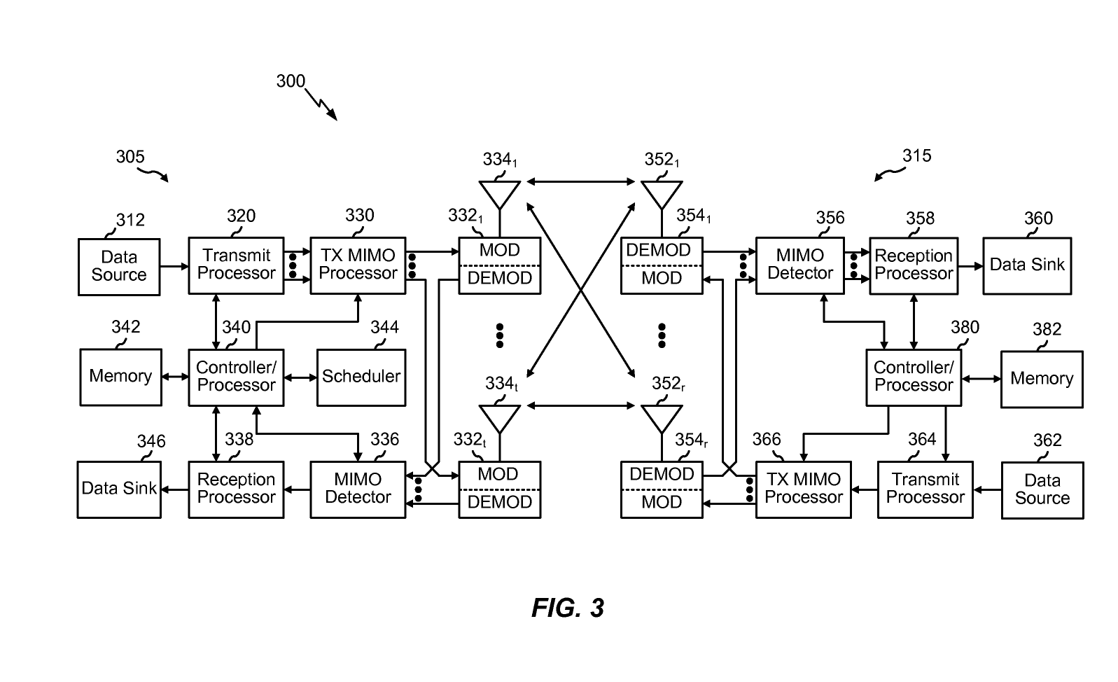

FIG. 3 is a block diagram conceptually illustrating an exemplary eNodeB 305 and an exemplary UE 315 configured in accordance with an aspect of the present disclosure. For example, the UE 315 may be an example of the multi-mode UE 115-a shown in FIG. 1 and capable of assisting in an offloading process by determining which RAT network to use to for routing data for certain applications based on network information, in accordance with aspects of the present disclosure.

The base station 305 may be equipped with antennas 334₁₋ₜ, and the UE 315 may be equipped with antennas 352₁₋ᵣ, wherein t and r are integers greater than or equal to one. At the base station 305, a base station transmit processor 320 may receive data from a base station data source 312 and control information from a base station controller/processor 340. The control information may be carried on the PBCH, PCFICH, PHICH, PDCCH, etc. The data may be carried on the PDSCH, etc. The base station transmit processor 320 may process (e.g., encode and symbol map) the data and control information to obtain data symbols and control symbols, respectively. The base station transmit processor 320 may also generate reference symbols, e.g., for the PSS, SSS, and cell-specific reference signal (RS). A base station transmit (TX) multiple-input multiple-output (MIMO) processor 330 may perform spatial processing (e.g., precoding) on the data symbols, the control symbols, and/or the reference symbols, if applicable, and may provide output symbol streams to the base station modulators/demodulators (MODs/DEMODs) 332₁₋ₜ. Each base station modulator/demodulator 332 may process a respective output symbol stream (e.g., for OFDM, etc.) to obtain an output sample stream. Each base station modulator/demodulator 332 may further process (e.g., convert to analog, amplify, filter, and upconvert) the output sample stream to obtain a downlink signal. Downlink signals from modulators/demodulators 332₁₋ₜ may be transmitted via the antennas 334₁₋ₜ, respectively.

At the UE 315, the UE antennas 352₁₋ᵣ may receive the downlink signals from the base station 305 and may provide received signals to the UE modulators/demodulators (MODs/DEMODs) 354₁₋ᵣ, respectively. Each UE modulator/demodulator 354 may condition (e.g., filter, amplify, downconvert, and digitize) a respective received signal to obtain input samples. Each UE modulator/demodulator 354 may further process the input samples (e.g., for OFDM, etc.) to obtain received symbols. A UE MIMO detector 356 may obtain received symbols from all the UE modulators/demodulators 354₁₋ᵣ, and perform MIMO detection on the received symbols if applicable, and provide detected symbols. A UE reception processor 358 may process (e.g., demodulate, deinterleave, and decode) the detected symbols, provide decoded data for the UE 315 to a UE data sink 360, and provide decoded control information to a UE controller/processor 380.

On the uplink, at the UE 315, a UE transmit processor 364 may receive and process data (e.g., for the PUSCH) from a UE data source 362 and control information (e.g., for the PUCCH) from the UE controller/processor 380. The UE transmit processor 364 may also generate reference symbols for a reference signal. The symbols from the UE transmit processor 364 may be precoded by a UE TX MIMO processor 366 if applicable, further processed by the UE modulator/demodulators 354₁₋ᵣ (e.g., for SC-FDM, etc.), and transmitted to the base station 305. At the base station 305, the uplink signals from the UE 315 may be received by the base station antennas 334, processed by the base station modulators/demodulators 332, detected by a base station MIMO detector 336 if applicable, and further processed by a base station reception processor 338 to obtain decoded data and control information sent by the UE 315. The base station reception processor 338 may provide the decoded data to a base station data sink 346 and the decoded control information to the base station controller/processor 340.

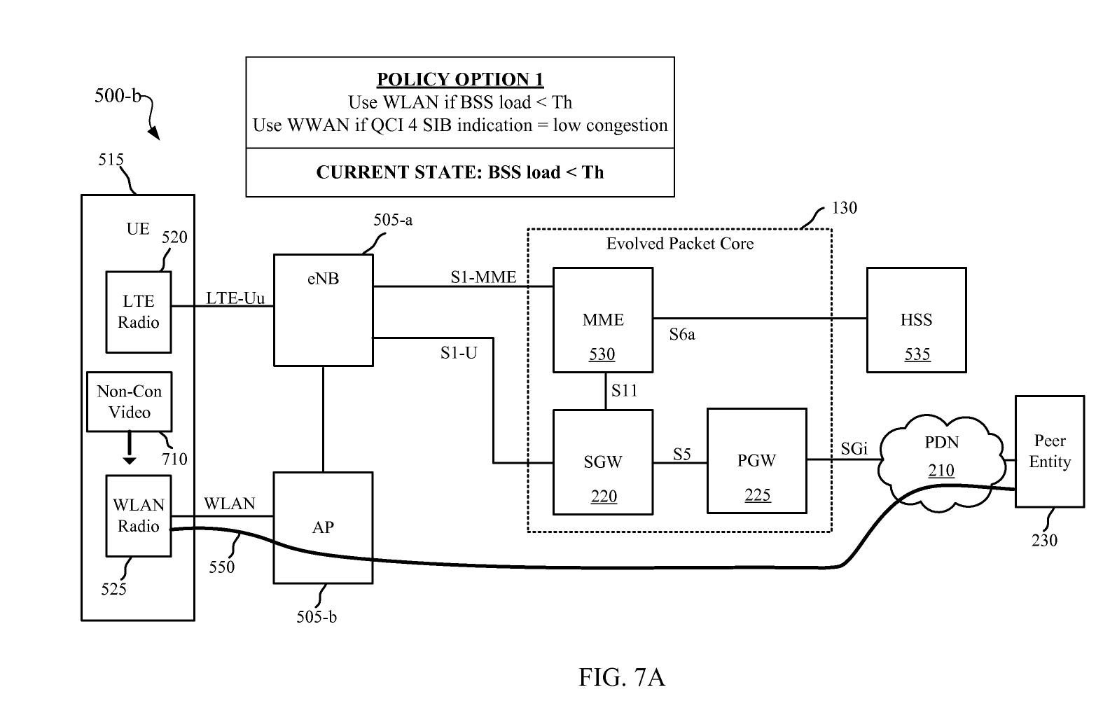

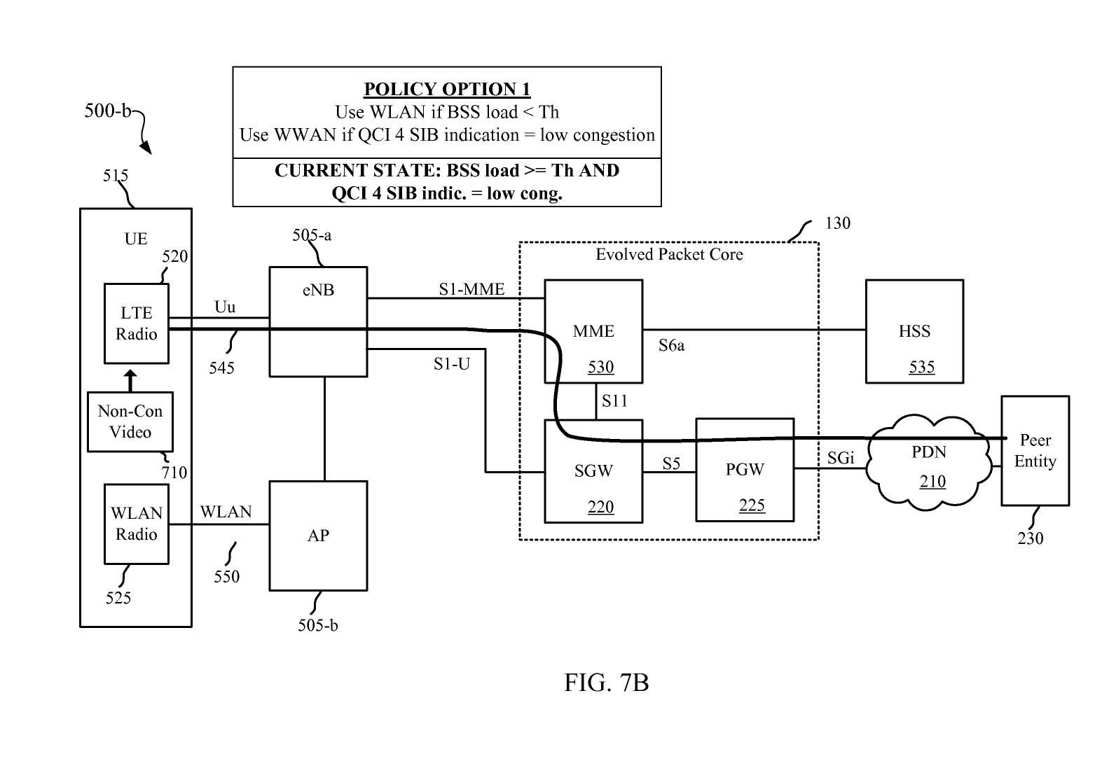

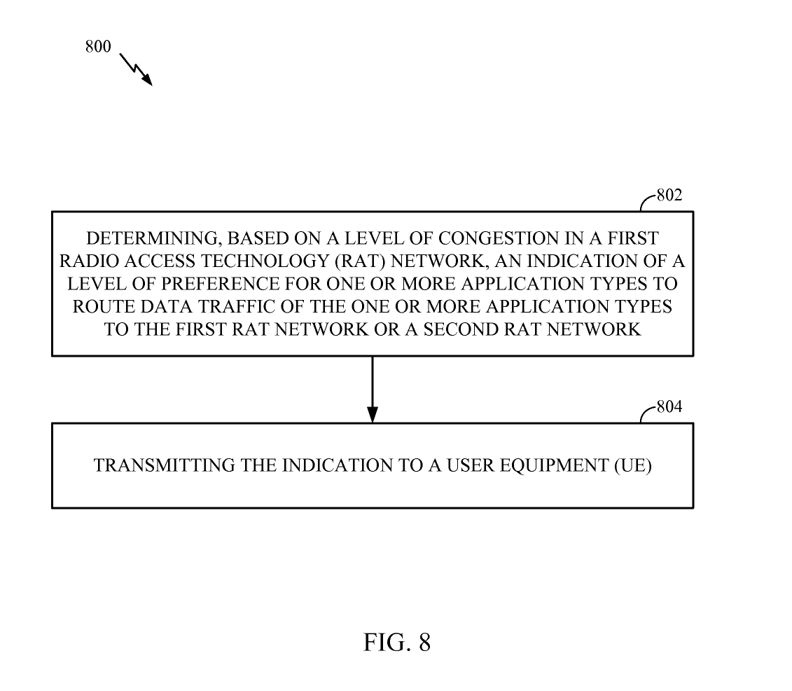

The base station controller/processor 340 and the UE controller/processor 380 may direct the operation at the base station 305 and the UE 315, respectively. The base station controller/processor 340 and/or other processors and modules at the base station 305 may perform or direct, e.g., the execution of various processes for the techniques described herein. The base station controller/processor 340 and/or other processors and modules at the base station 305 may also perform or direct, e.g., the execution of the functional blocks illustrated in FIG. 7, and/or other processes for the techniques described herein. Similarly, the UE controller/processor 380 and/or other processors and modules at the UE 315 may also perform or direct, e.g., the execution of the functional blocks illustrated in FIG. 8, and/or other processes for the techniques described herein. The base station memory 342 and the UE memory 382 may store data and program codes for the base station 305 and the UE 315, respectively. A scheduler 344 may schedule UEs 315 for data transmission on the downlink and/or uplink.

FIG. 4 illustrates a block diagram conceptually illustrating an aggregation of LTE and WLAN radio access technologies at a user equipment (UE), in accordance with an aspect of the present disclosure. The aggregation may occur in a system 400 including a multi-mode UE 415, which can communicate with an eNodeB 405-a using one or more component carriers 1 through N (CC1-CCN), and with a WLAN access point (AP) 405-b using WLAN carrier 440.

The UE 415 may be an example of UE 115-a described above with reference to FIG. 1. The UE 415 may, thus, be capable of assisting in an offloading process by determining whether to route traffic to via eNodeB 405-a or WLAN AP 405-b for certain applications based on network information, in accordance with aspects of the present disclosure.

The eNodeB 405-a may be an example of one or more of the eNodeBs or base stations 105 described above with reference to the previous Figures. While only one UE 415, one eNodeB 405-a, and one AP 405-b are illustrated in FIG. 4, it will be appreciated that the system 400 can include any number of UEs 415, eNodeBs 405-a, and/or APs 405-b.

The eNodeB 405-a can transmit information to the UE 415 over forward (downlink) channels 432-1 through 432-N on LTE component carriers CC1 through CCN 430. In addition, the UE 415 can transmit information to the eNodeB 405-a over reverse (uplink) channels 434-1 through 434-N on LTE component carriers CC1 though CCN. Similarly, the AP 405-b may transmit information to the UE 415 over forward (downlink) channel 452 on WLAN carrier 440. In addition, the UE 415 may transmit information to the AP 405-b over reverse (uplink) channel 454 of WLAN carrier 440.

In describing the various entities of FIG. 4, as well as other figures associated with some of the disclosed embodiments, for the purposes of explanation, the nomenclature associated with a 3GPP LTE or LTE-A wireless network is used. However, it is to be appreciated that the system 400 can operate in other networks such as, but not limited to, an OFDMA wireless network, a CDMA network, a 3GPP2 CDMA2000 network and the like.

FIGS. 5A and 5B are block diagrams conceptually illustrating examples of data paths 545, 550 between a UE 515 and a PDN (e.g., the Internet), in accordance with an aspect of the present disclosure. The UE 515 may be an example of UE 115-a or UE 415 described above with reference to FIGS. 1 and 4. The UE 515 may, thus, be capable of assisting in an offloading process by determining whether to route traffic to via eNodeB 505-a or WLAN AP 505-b for certain applications based on network information, in accordance with aspects of the present disclosure.

The data paths 545, 550 are shown within the context of a wireless communication system 500-a, 500-b aggregating WLAN and LTE radio access technologies. In each example, the wireless communication system 500-a and 500-b, shown in FIGS. 5A and 5B, respectively, may include a multi-mode UE 515, an eNodeB 505-a, a WLAN AP 530, an evolved packet core (EPC) 130, a PDN 210, and a peer entity 230. The EPC 130 of each example may include a mobility management entity (MME) 505, a serving gateway (SGW) 220, and a PDN gateway (PGW) 225. A home subscriber system (HSS) 535 may be communicatively coupled with the MME 530. The UE 515 of each example may include an LTE radio 520 and a WLAN radio 525. These elements may represent aspects of one or more of their counterparts described above with reference to the previous Figures.

Referring specifically to FIG. 5A, the eNodeB 505-a and AP 530 may be capable of providing the UE 515 with access to the PDN 210 using the aggregation of one or more LTE component carriers or one or more WLAN component carriers. Using this access to the PDN 210, the UE 515 may communicate with the peer entity 230. The eNodeB 505-a may provide access to the PDN 210 through the evolved packet core 130 (e.g., through path 545), and the WLAN AP 530 may provide direct access to the PDN 210 (e.g., through path 550).

The MME 530 may be the control node that processes the signaling between the UE 515 and the EPC 130. Generally, the MME 530 may provide bearer and connection management. The MME 530 may, therefore, be responsible for idle mode UE tracking and paging, bearer activation and deactivation, and SGW selection for the UE 515. The MME 530 may communicate with the eNodeB 505-a over an S1-MME interface. The MME 530 may additionally authenticate the UE 515 and implement Non-Access Stratum (NAS) signaling with the UE 515.

The HSS 535 may, among other functions, store subscriber data, manage roaming restrictions, manage accessible access point names (APNs) for a subscriber, and associate subscribers with MMEs 530. The HSS 535 may communicate with the MME 530 over an S6a interface defined by the Evolved Packet System (EPS) architecture standardized by the 3GPP organization.

All user IP packets transmitted over LTE may be transferred through eNodeB 505-a to the SGW 220, which may be connected to the PDN gateway 225 over an S5 signaling interface and the MME 530 over an S11 signaling interface. The SGW 220 may reside in the user plane and act as a mobility anchor for inter-eNodeB handovers and handovers between different access technologies. The PDN gateway 225 may provide UE IP address allocation as well as other functions.

The PDN gateway 225 may provide connectivity to one or more external packet data networks, such as PDN 210, over an SGi signaling interface. The PDN 210 may include the Internet, an Intranet, an IP Multimedia Subsystem (IMS), a Packet-Switched (PS) Streaming Service (PSS), and/or other types of PDNs.

In the present example, user plane data between the UE 515 and the EPC 130 may traverse the same set of one or more EPS bearers, irrespective of whether the traffic flows over path 545 of the LTE link or path 550 of the WLAN link. Signaling or control plane data related to the set of one or more EPS bearers may be transmitted between the LTE radio 520 of the UE 515 and the MME 530 of the EPC 130-b, by way of the eNodeB 505-a.

FIG. 5B illustrates an example system 500-b in which the eNodeB 505-a and AP 505-b are collocated or otherwise in high-speed communication with each other. In this example, EPS bearer-related data between the UE 515 and the WLAN AP 505-b may be routed to the eNodeB 505-a, and then to the EPC 130. In this way, all EPS bearer-related data may be forwarded along the same path between the eNodeB 505-a, the EPC 130, the PDN 210, and the peer entity 230.

### Broadcasting Per Application Type Load Information to Enable A UE to Select Different Network Access

In general, offloading traffic to a wireless local area network (WLAN) may be desirable in many cases, because operator deployed WLAN networks are often under-utilized. However, user experience will likely be suboptimal if a UE connects to an overloaded WLAN network. As noted above, unnecessary WLAN scanning may drain UE battery resources and increase WLAN traffic. The following description generally refers to base stations of WLANs as access points (APs) and to base stations of WWANs, such as LTE networks, as eNodeBs (or eNBs).

One objective of service providers of WWAN and/or WLAN networks may be to identify solutions that enable enhanced operator control for WWAN and WLAN interworking, and to enable WLAN to be included in the operator's cellular Radio Resource Management (RRM). Another objective may be to identify enhancements to access network mobility and selection which take into account information, such as radio link quality per UE, backhaul quality, and load for both WWAN and WLAN accesses. Aspects of the present disclosure may allow a UE to help in offloading on a “per-application” basis, for example, based on network provided information. The techniques may be utilized to make determinations regarding offloading for a variety of different application types, such as video streaming, instant messaging (IM) services, blogging, games, social networking, file transfer protocol (FTP) or other software downloads, or any other type of application. In some cases, decisions may also be made regarding offloading different instances of the same application (running on the same UE).

In some cases, the UE may need different types of information in order to make decisions regarding traffic offloading for different types of applications. For example, some applications are symmetric (with relatively similar uplink and downlink traffic loads) while others are asymmetric, therefore loading information for both downlink and uplink may be considered. Further, different applications may have different requirements regarding jitter tolerance, Quality of Service Class Identifiers (QCI), latency, and capacity. Further, some applications may need different granularity of information. For example, some thresholds may be advertised in relatively coarse granularity, such as “above x mbps” for applications involving relatively low resolution video, while thresholds may be advertised in finer granularity, such as “y mbps” for applications involving high definition (HD) video.

For one example UE behavior case (referred to herein as case 1), a UE may default to use WLAN if WLAN provides sufficient level of service (e.g., regardless of WWAN conditions). When both WLAN and WWAN networks are congested (e.g., neither provides what might be considered a sufficient level of service), the UE may use the least congested.

For another UE behavior case (referred to herein as case 2), a UE may determine how to route traffic based on relative quality of WWAN and WLAN. For example, the UE may compare WWAN quality with WLAN quality and select to use the best quality of service. In either case 1 or 2, the RAT network selection may assume that the UE makes a decision based on determining which RAT network is best (e.g., at least sufficient, least congested) for access. In some cases, there may be a bias towards one or the other based on relative loading.

The level of information provided for making offloading decisions may vary. For example, the least information provided may be for bias only. In this case, an indication of network capacity level may be provided. In an exemplary embodiment, the network capacity level may indicate whether the communication network has sufficient capacity (e.g., bandwidth) to support an application requested by the UE. For example, the network capacity level may include a congestion level (e.g., low congestion, medium congestion and access barred for a type of application) of the WWAN.

The UE may determine whether to switch over to WLAN based at least in part on the indication of network capacity level. In some cases, a network may indicate how to balance a load between WLAN and WWAN. This may take into consideration backhaul coordination that can be used to manage the loading more effectively. This approach may also need to consider the scenario when multiple WLAN access points (APs) correspond to a single (e)NodeB and how to load balance when some of the multiple WLAN APs are loaded while others are not.

In some cases, the WWAN may broadcast a bias towards selecting WLAN. In such cases, a UE may make a decision to select WWAN or WLAN, with the decision weighted based on bias and WLAN load. Such a bias may be implemented, for example, by assigning a bias value that may represent a particular RAT network should be favored (e.g., a desired probability) when making offloading decisions. A UE may use this bias value to effectively adjust relative loading of the different RAT networks, for example, by adjusting threshold values (e.g., of WLAN) used in making routing determinations or adjusting load/congestion values (e.g., of WWAN) received for the different RAT networks. For example, a bias value corresponding to 75% may indicate WLAN should be selected using an algorithm that results in the UE offloading to WLAN 3 out of 4 times, if all other factors considered being equal (e.g., same or similar loading). Such a bias value favoring WLAN may also result in WLAN still being selected in cases where relative WLAN loading exceeds WWAN within some limits. This approach may have an advantage that it is easy to control UE behavior. However, bias may not actually give a UE any information as to whether the WWAN or WLAN has sufficient capacity to support application requirements (i.e., this approach may move a UE between WWAN and WLAN but not necessarily dependent on what the application requirements are). This approach also may assume some kind of coordination between WLAN and WWAN to bias correctly to avoid rapid switching (toggling or Ping-Pong effect) between WLAN and WWAN.

More information may be need to be considered when a UE determining whether to route traffic through WLAN or WWAN. In this case, a network may provide system information to allow the UE to determine whether to select WWAN or WLAN, based at least in part on application parameters. This may be compatible with WLAN information, so a UE can easily compare expected user experience. Such information may be rich enough for the UE to evaluate connection for different application types (e.g., UL and DL info).

In an exemplary embodiment, the network may broadcast available capacity information based at least in part on an application and a UE may determine whether to select WWAN or WLAN, based on the broadcasted available capacity information and application parameters (for applications). For example, a network may broadcast admission control information based at least in part on an application to the UE. The network (e.g., via a NodeB or eNodeB) may broadcast the admission control information in system information blocks (SIBs) based at least in part on an application. The UE may compare the received admission control information with one or more application parameters to determine which networks (e.g., WWAN or WLAN) to select. As noted above, for various reasons, there may be a bias to use WLAN. Advantages of this approach may be that it is flexible to accommodate future application requirements. Further, this approach does not require the WWAN to have knowledge of WLAN loading, as evaluation of WLAN loading is performed by the UE. In the event WLAN is loaded, the UE knows whether WWAN has sufficient network capacity to provide requested service and, if so, may route traffic to WWAN.

As noted above, the UE may need different types of information for different applications to make a decision regarding traffic offloading. Further, different types of information may be needed for the UE or the network to determine capacity in various types of network and, may be dependent on an application type. For example, in some cases, only DL information may be needed (e.g., available codes for UMTS). In some cases, more detailed information may be needed, such as particular loading experienced in both uplink and downlink, channel quality, packet delays and/or packet error rates observed, and the like). In some cases, such as LTE networks, physical resource block (PRB) utilization and a number of users (e.g., on DL), and/or interference over thermal noise (IOT) on UL may be utilized.

As noted above, one approach to manage traffic is for the network to broadcast capacity information based at least in part on an application to allow a user equipment (UE) to decide whether to route traffic via WWAN or WLAN. For example, the UE can determine whether there is sufficient capacity based on the application parameters of the applications running to select the different networks (e.g., WWAN or WLAN). Also, the UE may determine where and when to select the different networks (e.g., WWAN or WLAN) based at least in part on the determination of whether sufficient capacity exists on different networks to support the application. In addition to this, policies such as Access Network Discovery and Selection Function (ANDSF) may allow the network to control where the UE accesses based, for example, on the traffic or application type.

Some of these policies may evolve to handle load as well. For example, a policy could be defined for the UE to use WLAN for a specific traffic flow template (TFT), unless WLAN load is above a threshold. Otherwise, the UE may use WWAN, if available. The policies stored on the UE may help control the UE behavior and provide a consistent user experience. On the network side, the broadcast of capacity information may help achieve load balancing and redirect the UE to a network using a different RAT network when the serving RAT network is congested (e.g., based on limited backhaul or access resources). This may provide real time control of traffic flow in the network via the policies.

In this manner, the UE may use the network indication and the current service requirements of its applications to decide whether to offload the service to WLAN (or alternatively postpone access to the RAT network if WLAN is unavailable based on the indication in the SIBs. Alternatively, the UE behavior may be randomized, e.g., apply a random backoff as to when to select one RAT network over the other.

According to certain aspects, the application type may be related to one or more Quality of Service Class Identifiers (QCIs). In general, QCI specifies the treatment of IP packets received on a specific bearer. Various application types may correspond to one or more defined QCI values (e.g., defined in 3GPP TS 23.203). In this case, the UE may decide whether to select the different networks based on which bearers are currently established. For example, if a QCI 4 (streaming video) indication is set to medium congestion, then the UE may decide, based on traffic for a radio/evolved packet system (EPS) bearer corresponding to QCI 4, to use WLAN instead of the WWAN for the traffic.

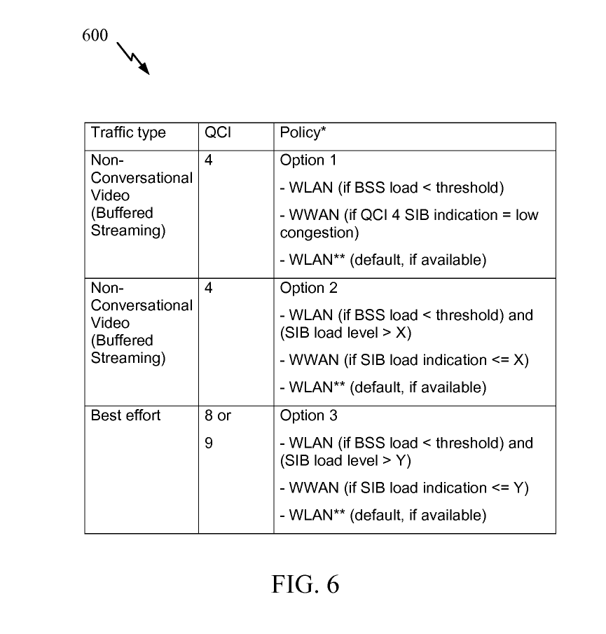

FIG. 6 illustrates a table 600 with exemplary policies for managing different types of traffic for different application types having (in some cases) different QCI values, in accordance with certain aspects of the present disclosure. According to certain aspects, a UE may apply a policy that matches the first acceptable behavior in the list.

For example, for non-conversational video (e.g., buffered streaming) application that may having a QCI of 4, one policy (labeled as Option 1 in FIG. 6) may be to route traffic through WLAN if it is not congested (e.g., as indicated by loading below a threshold value). If WLAN is congested, traffic may be routed to WWAN if it is not congested (e.g., as indicated by a SIB parameter if QCI 4 indicates low congestion).

FIGS. 7A and 7B illustrate an exemplary application of this policy in the exemplary system 500-b of FIG. 5B. As illustrated in FIG. 7A, if a current state of system 500-b is that WLAN loading is below the threshold value (Th), non-conversational video data 710 is routed through WLAN data path 550. As illustrated in FIG. 7B, if a current state of system 500-b is that WLAN loading is at or above the threshold value (Th) and the SIB parameter indicates that QCI 4 equals low congestion in WWAN, non-conversational video data 710 is routed through WWAN data path 545.

Referring back to FIG. 6, as a default option, if neither of the first two conditions of the policy are met, traffic may be routed through WLAN. For example, different application types with different QCI values may have similar requirements and may have similar policies. For example, applications with QCI 4 and QCI 6 may have the same packet delay budgets and packet error loss rates and may have similar policies.

In another example, different policies may be applicable to the same application types having the same QCI value. For example, FIG. 6 also illustrates a second policy (labeled as Option 2) for non-conversational video (e.g., buffered streaming) application that may have a QCI of 4. As illustrated, for Option 2, the policy may be to route traffic through WLAN if it is not congested and the WWAN's congestion level is above a threshold (e.g., as indicated by an SIB load level above a threshold level X). If both of these conditions are not met, traffic may be routed to WWAN if it is congestion level is below a threshold (e.g., as indicated by the SIB load level equal to or less than the threshold X). As a default option, if neither of the first two options are met, traffic may be routed through WLAN.

Different policies may be defined for a same QCI value for different reasons. As an example, different operators may want to set different policies for each UE. As another example, an individual UE may have multiple policies for the same QCI for different specific instances of a same type of application (e.g., depending on whether streamed content is paid for or free).

In other examples, a third policy (labeled as Option 3) for “best effort” application type traffic having a QCI of 8 or 9 (for traffic with guaranteed bit rates), the policy may be to route traffic through WLAN if its congestion level is below a threshold (e.g., as indicated by loading below a threshold value) and the WWAN has a congestion level above a threshold (e.g., as indicated by an SIB load level above a threshold level Y). If both of these conditions are not met, traffic may be routed to WWAN if its congestion level is below a threshold (e.g., as indicated by the SIB load level equal to or less than the threshold Y). As a default option, if neither of the first two options are met, traffic may be routed through WLAN.

In the example policies shown in FIG. 6, the UE may default to using WLAN, if available, In some cases, the UE may still decide not to connect to WWAN even if WLAN is not available (e.g., if the system SIB indication is medium congestion or higher). In this case, the UE may simply choose to postpone access until one or more of the policy conditions are satisfied.

In accordance with aspects of the present disclosure, the suitability of a second RAT network, such as for a WLAN, for offloading traffic may be determined by one or more of: measurements of the second RAT network. For example, one or more measurement of the second RAT network may include Received Channel Power Indicator (RCPI), over-the-air (OTA) IEs received in a beacon or probe response from the WLAN, 802.11u, 802.11k or Hotspot 2.0 IEs received over ANQP or in the beacon or probe response.

FIG. 8 illustrates example method 800 for managing traffic, in accordance with certain aspects of the present disclosure. The method 800 may be performed, for example, by an eNodeB, such as eNodeB 505-a shown in FIG. 5 (or some other type of base station/access point).

The method 800 may begin, at block 802, by determining, based on a level of congestion in a first radio access technology (RAT) network, an indication of a level of preference for one or more application types to route data traffic of the one or more application types to the first RAT network or a second RAT network. Routing the data traffic may involve one or more of: establishing a connection, registering, initiating a discovery of, or transmitting data, via the first or second RAT network. In some cases, a base station in the first RAT network may obtain loading information from a base station in the second RAT network. For example, an eNodeB may obtain WLAN congestion information by communicating directly with a WLAN AP.

Level of preference per application type may be indicated in different ways. For example, in some cases, relative levels of preference may be indicated, for example, with different values (e.g., 0, 1, or 2) corresponding to a low preference, medium preference, and high preference. When making offloading decisions, for example, a UE may apply policies such as those shown in FIG. 6, with threshold values adjusted based on the indicated preference level. For example, referring to the first policy (Option 1) for a non-conversational video (buffered streaming) having a QCI of 4, if a high level of preference to switch to WLAN is indicated, the threshold value for WLAN offloading may be set relatively high, causing more traffic to be offloaded to WLAN. On the other hand, if a low level of preference to switch to WLAN is indicated, the threshold value for WLAN offloading may be set relatively low, causing less traffic to be offloaded to WLAN.

At 804, the eNodeB may transmit the indication to a user equipment (UE). In accordance with certain aspects of this disclosure, the eNodeB may transmit the indication of levels of preference for offloading traffic via dedicated or broadcast RRC signaling (in a new or existing information element (IE)). In some cases, the eNodeB may broadcast the indication of levels of preference in a SIB (e.g., using new SIB parameters or available/repurposed bits of existing parameters). As noted above, the levels of preference which the UE is capable of determining may include one or more of low preference, medium preference, or high preference. In some cases, a level of preference may indicate access for this application type barred (e.g., if that application may not be offloaded to WLAN or is barred from WWAN and should always be offloaded to WLAN when available).

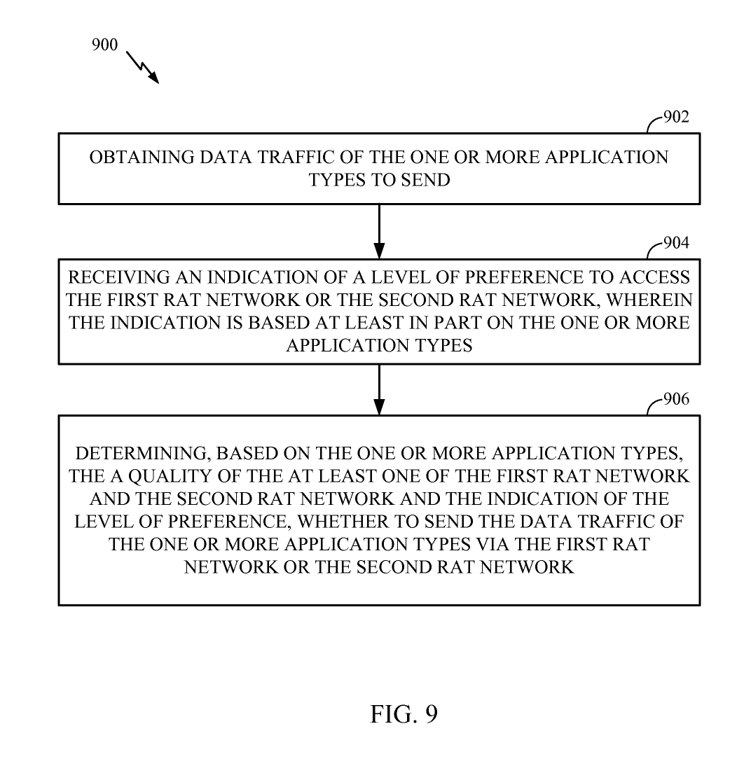

FIG. 9 illustrates example method 900 for managing traffic, in accordance with certain aspects of the present disclosure. The method 900 may be performed, for example, by a multimode UE (such as multi-mode UE 515 shown in FIG. 5) to determine whether to send data of an application on a first RAT network or a second RAT network.

The method 900 may begin, at block 902, by obtaining data traffic of the one or more application types to send. At block 904, the UE receives an indication of a level of preference to access the first RAT network or the second RAT network, wherein the indication is based at least in part on the one or more application types. At block 906, the UE determines, based on the one or more application types, a quality of the at least one of the first RAT network and the second RAT network and the indication of the level of preference, whether to send the data traffic of the one or more application types via the first RAT network or the second RAT network.

The techniques disclosed herein may be applicable for a variety of applications or application types, or combinations of applications and application types. The applications, or combinations thereof, may include, but are not limited to, video streaming, IM services, blogging, games, social networking, FTP or other software downloads. As noted above, one or more of the application types may be application types which correspond to a QCI value. As also noted above, different offloading policies may be applied to different specific applications of the same type or different instances of the same application.

Furthermore, the eNodeB may determine the level of preference based on one or more of the availability (current use) of network resources compared to a capacity of such resources (uplink or downlink), a backhaul capacity, processing capability, and/or any other suitable criteria. The indication of preference per application type may be based on the level of congestion of the resources required for the application (e.g., since applications may be symmetric or asymmetric, congestion on the UL may be more relevant to some applications than others).

According to certain aspects, the level of preference may comprise an available capacity at the first RAT network for an application type, current load, or congestion level at the first RAT network for an application type.

As noted above, application types may correspond to QCIs. According to certain aspects, the application types comprise at least one of: video streaming, instant messaging (IM) services, blogging, games, social networking, file transfer protocol (FTP), or other software downloads. According to certain aspects, the level of preference is determined based on at least one of: availability of network resources relative to a capacity, a backhaul capacity, or processing capability.

According to certain aspects, the indication of preference per application type is based on at least one or more of: a level of load or congestion of resources required for that application or a level of available resources available for that application. In some cases, resources required for at least one application may be asymmetric, such that uplink (UL) resource requirements are different from downlink (DL) resource requirements (e.g., streaming applications may require much more DL resources than UL resources).

According to certain aspects, the indication of the level of preference may essentially comprises an indication of available capacity for the application in the first RAT network (e.g., WWAN) or the second RAT network (e.g., WLAN) (wherein capacity comprises a number of applications that can be admitted or available throughput, latency, etc.). The techniques may involve changing the level of preference based on the determined quality of the second RAT network (e.g., WLAN), for example, increasing the level of preference as the second RAT network (e.g.,WLAN) quality becomes poorer and vice versa. In some cases, the first RAT network (e.g., WWAN) may obtain information about the quality of the second RAT network (e.g., WLAN) from one or more WLAN APs, over the air (OTA) or via a wired backhaul connection (e.g., an X2 interface).

In some cases, determining whether to send the application data via the first RAT network or the second RAT network comprises determining neither is suitable and implementing a backoff (with a backoff period that may be fixed or random). For example, the UE may simply refrain from routing traffic through either network for the specified backoff period and then re-evaluate to determine if either network is suitable. If neither RAT network is available after a certain number of backoff periods, the UE may stop trying and terminate a corresponding application or applications.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a mobile station and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a mobile station and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1. A method for managing load at a wireless node, comprising:
determining, based on a level of congestion in a first radio access technology (RAT) network, an indication of a level of preference for one or more application types to route data traffic of the one or more application types to the first RAT network or a second RAT network; and
transmitting the indication to a user equipment (UE).

2. The method of claim 1, wherein routing data traffic comprises one or more of: establishing a connection, registering, initiating a discovery of, or transmitting data, via the first RAT network or the second RAT network.

3. The method of claim 1, wherein the indication comprises a field for each of the one or more application types, indicating a level of preference for routing the data traffic of each of the one or more application types from the first RAT network to the second RAT network or from the second RAT network to the first RAT network.

4. The method of claim 1, wherein the second RAT network comprises a wireless local area network (WLAN) and the first RAT network comprises a wireless wide area network (WWAN).

5. The method of claim 1, wherein transmitting the indication to the UE comprises at least one of:
transmitting the indication via dedicated radio resource control (RRC) signaling; or
broadcasting the indication via common RRC signaling.

6. The method of claim 1, wherein the indication comprises one or more of
a value indicating a bias for routing traffic to the second RAT network instead of the first RAT network for the one or more application types;
an available capacity at the first RAT network for the one or more application types;
a level of load or congestion of resources at the first RAT network for the one or more application types; and
a level of available resources available at the first RAT network for the one or more application types.

7. A method for determining whether to send traffic on a first radio access technology (RAT) network or a second RAT network for one or more application types, comprising:
obtaining data traffic of the one or more application types to send;
receiving an indication of a level of preference to access the first RAT network or the second RAT network, wherein the indication is based at least in part on the one or more application types; and
determining, based on the one or more application types, a quality of the at least one of the first RAT network and the second RAT network and the indication of the level of preference, whether to send the data traffic of the one or more application types via the first RAT network or the second RAT network.

8. The method of claim 7, wherein the indication comprises a field, per application type, indicating the level of preference for an application type of the one or more application types.

9. The method of claim 7, wherein the second RAT network comprises a wireless local area network (WLAN) and the first RAT network comprises a wireless wide area network (WWAN).

10. The method of claim 7, wherein receiving the indication comprises receiving the indication via at least one of:
dedicated radio resource control (RRC) signaling; or
common RRC signaling broadcast in a system information block (SIB).

11. The method of claim 7, wherein the indication comprises one or more of:
a value indicating a bias for offloading traffic to the second RAT network instead of the first RAT network for the one or more application types;
an available capacity at the first RAT network for the one or more application types
a level of load or congestion of resources at the first RAT network for the one or more application types; and
a level of available resources available at the first RAT network for the one or more application types.

12. An apparatus for managing load at a wireless node, comprising:
at least one processor configured to determine, based on a level of congestion in a first radio access technology (RAT) network, an indication of a level of preference for one or more application types to route data traffic of the one or more application types to the first RAT network or a second RAT network; and
a transmitter configured to transmit the indication to a user equipment (UE).

13. The apparatus of claim 12, wherein routing data traffic comprises one or more of: establishing a connection, registering, initiating a discovery of, or transmitting data, via the first RAT network or the second RAT network.

14. The apparatus of claim 12, wherein the indication comprises a field for each of the one or more application types, indicating a level of preference for routing the data traffic of each of the one or more application types from the first RAT network to the second RAT network or from the second RAT network to the first RAT network.

15. The apparatus of claim 12, wherein the second RAT network comprises a wireless local area network (WLAN) and the first RAT network comprises a wireless wide area network (WWAN).

16. The apparatus of claim 12, wherein the transmitter is configured to transmit the indication to the UE by at least one of:
transmitting the indication via dedicated radio resource control (RRC) signaling; or
broadcasting the indication via common RRC signaling.

17. The apparatus of claim 12, wherein the indication comprises one or more of
a value indicating a bias for routing traffic to the second RAT network instead of the first RAT network for the one or more application types;
an available capacity at the first RAT network for the one or more application types;
a level of load or congestion of resources at the first RAT network for the one or more application types; and
a level of available resources available at the first RAT network for the one or more application types.

18. An apparatus for determining whether to send traffic on a first radio access technology (RAT) network or a second RAT network for one or more application types, comprising:
a receiver configured to receive an indication of a level of preference to access the first RAT network or the second RAT network, wherein the indication is based at least in part on one or more application types;
at least one processor configured to obtain data traffic of the one or more application types to send and determine, based on the one or more application types, a quality of the at least one of the first RAT network and the second RAT network and the indication of the level of preference, whether to send the data traffic of the one or more application types via the first RAT network or the second RAT network.

19. The apparatus of claim 18, wherein the indication comprises a field, per application type, indicating the level of preference for an application type of the one or more application types.

20. The apparatus of claim 18, wherein the second RAT network comprises a wireless local area network (WLAN) and the first RAT network comprises a wireless wide area network (WWAN).

21. The apparatus of claim 18, wherein the receiver is configured to receive the indication via at least one of:
dedicated radio resource control (RRC) signaling; or
common RRC signaling broadcast in a system information block (SIB).

22. The apparatus of claim 18, wherein the indication comprises one or more of:
a value indicating a bias for offloading traffic to the second RAT network instead of the first RAT network for the one or more application types;
an available capacity at the first RAT network for the one or more application types
a level of load or congestion of resources at the first RAT network for the one or more application types; and
a level of available resources available at the first RAT network for the one or more application types.
